(19) United States
(12) Patent Application Publication
(10) Pub. No.: US 2005/0183339 A1
(43) Pub. Date: Aug. 25, 2005

(54) Vehicle security screen

(76) Inventor: W.G. Bud Schaaf JR., Santa Claus, IN (US)

Correspondence Address: BOWERS HARRISON LLP;GARY K. PRICE, ESP., 25 RIVERSIDE DRIVE, PO BOX 1287, EVANSVILLE, IN, 47706-1287, US

(21) Appl. No.: 11/064,476

(22) Filed: Feb. 23, 2005

Related U.S. Application Data
(60) Provisional application No. 60/546,477, filed on Feb. 23, 2004.

(51) Int. Cl. E05F 11/38

(52) U.S. Cl. 49/54; 49/348; 49/374

(57) ABSTRACT

In application, the vehicle security screen is installed in the delivery vehicle such that an upper end of the serrated plate is received in the top portion of the vehicle's window encasement, the side ends of the serrated plate are received in the side ends of the vehicle's window encasement, and the security screen is them firmly held in place within the window encasement by the upper edge of the vehicle window engaged with the brackets. A vehicle's security screen that can be installed within a window frame of a vehicle door of a delivery vehicle. The vehicle security screen generally including a serrated plate and brackets. The brackets are affixed to a lower end of the serrated plate and brackets are sized to fit over and around a door window of a vehicle. In application, the vehicle security screen is installed in the delivery vehicle such that an upper end of the serrated security screen is installed in the delivery vehicle such that an upper end of the serrated plate is positioned into the inside top of the vehicle's window frame, and the security screen is firmly held in place within the window frame by the vehicle window engaged with the brackets. The serrated plate allows for some air circulation within the delivery vehicle and alleviates heat build-up in the vehicle.

### CROSS REFERENCES TO RELATED APPLICATIONS

U.S. Provisional Application for Patent No. 60/546,477, filed Feb. 23, 2004, with title “Vehicle Security System” which is hereby incorporated by reference. Applicant claims priority pursuant to 35 U.S.C. Par. 119(e)(i).

Statement as to rights to inventions made under federally sponsored research and development: Not Applicable

### BACKGROUND OF THE INVENTION

1. Field of the Invention

This invention relates generally to vehicle window screens, and more particular to a vehicle security screen insert applicable to a wide variety of vehicles for security and ventilation.

2. Brief Description of Prior Art

There has been increasing concern about and awareness of the vulnerability of a vehicular occupant to bodily injury or attack as a result of the relative ease of access to the occupant of a vehicle via the glass window of the door. For example, the U.S. Postal Service requires that the delivery vehicle's windows remain closed for security reasons while the vehicle is unattended. In this regard, the vehicle's glass windows may be easily broken, and provide little if any resistance to assault. In addition, this causes a problem with heat buildup in the delivery vehicle with the closed windows in the summertime in many areas.

As will be seen from the subsequent description of the preferred embodiments of the present invention, the present invention overcomes this and other shortcomings of the prior art.

### SUMMARY OF THE INVENTION

The present invention in the preferred embodiment is a security screen comprised such that the security screen can be installed, without tools, within a window frame of a vehicle door. The security screen generally includes a serrated plate and a pair of brackets. The brackets include a fastening portion affixed to a bottom end of the serrated plate, and a channel portion opposite the fastening portion. The channel portion is intended to receive and guide the glass pane of the vehicle's door window. In application, the security screen is positioned in the upper portion of the vehicle window, with a top end of the serrated plate placed in a top portion of the vehicle's window frame, and side ends of the serrated plate positioned in forward and rear side encasements of the vehicle's window frame, and an upper edge of the vehicle window glass pane is received in the channel portion of the brackets. Moving the window glass upward secures the security screen into the vehicle window encasement.

### BRIEF DESCRIPTION OF THE DRAWINGS

FIG. 1 is a perspective view of the present invention, a security screen.

FIGS. 2 and 3 illustrate installation of the security screen of FIG. 1 in a vehicle window.

FIG. 4 is a top view of the security screen of FIG. 1 installed in a vehicle window.

FIG. 4A is an enlarged view of dashed circle designated 4A shown in FIG. 4.

### DESCRIPTION OF THE PREFERRED EMBODIMENT

In accordance with the present invention, a vehicle security screen insert is disclosed. The vehicle security screen is directed to a screen insert applicable to a wide variety of vehicles, most suitably delivery vehicles, for security and ventilation. In the preferred embodiment, the present invention provides a shield window insert which may be inserted and retained within an opening of the vehicle's window that provides both security and ventilation. In the broadest context, the vehicle security screen consists of components configured and correlated with respect to each other so as to attain the desired objective.

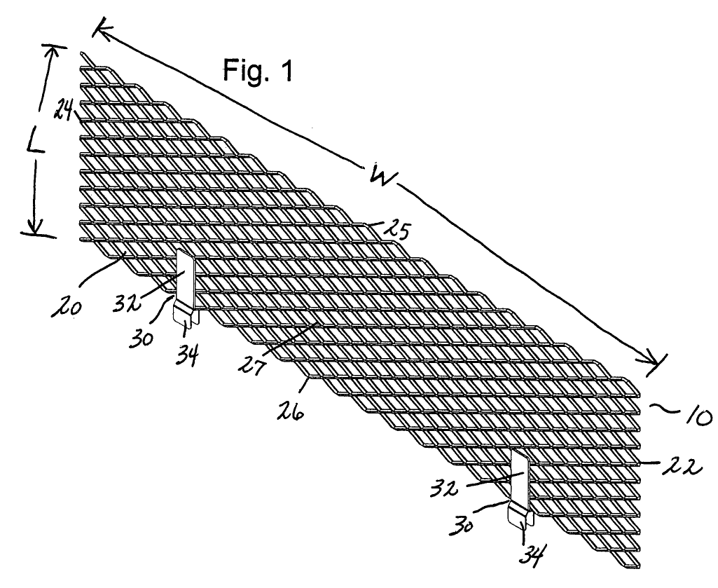

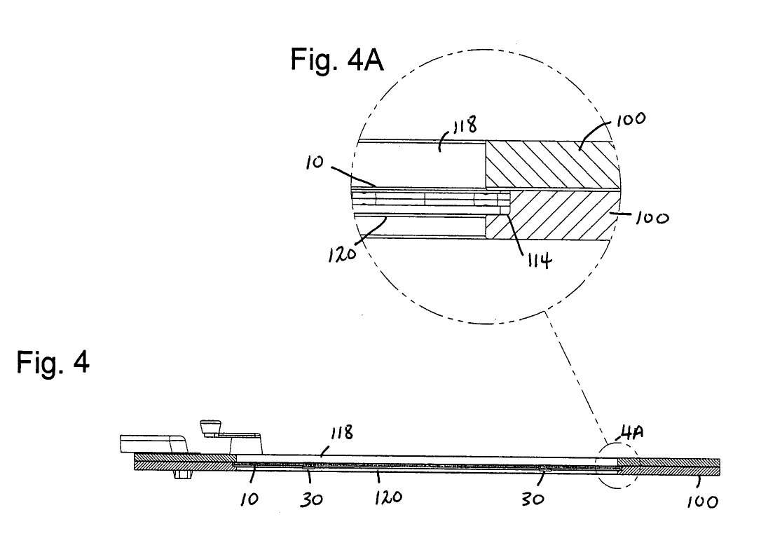

FIGS. 1-4A illustrate the preferred embodiment of a security screen 10 made in accordance with the present invention. The security screen 10 designed to be installed and retained within the opening of a window frame 100 of a vehicle door of a vehicle. The window frame 100 of the vehicle door is of conventional design and known in the art.

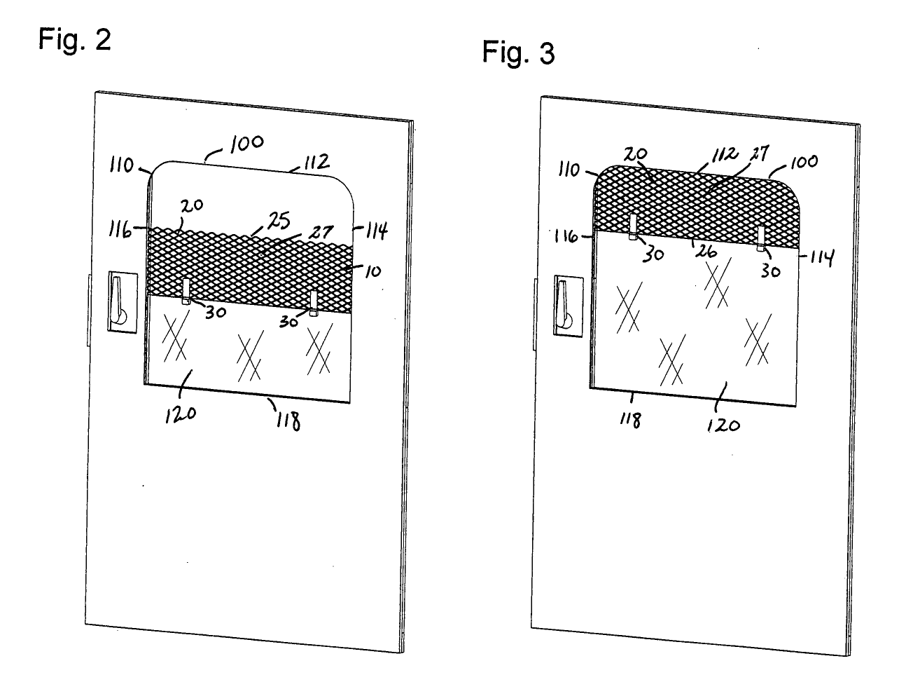

The vehicle window 100 includes an encasement 110 ordinarily used to receive and track a glass pane 120 of the vehicle. The encasement 110 includes a top encasement section 112, forward and rear side encasement sections 114 and 116, and a bottom encasement section 118. As shown in FIG. 2, the glass pane 120 is raised partially in the encasement 110 to engage the security screen 10. It can be seen that the security screen 10 fits securely and essentially sealingly for security and ventilation in the vehicle window 100. Additionally, the profile of the security screen 10 is such that it provides minimal disruption of vision out of vehicle window 100.

As best shown in FIG. 1, the security screen 10 of the present invention generally includes a serrated plate 20 and at least a pair of brackets 30. The serrated plate 20 having first and second ends 22, 24, a top end 25 and a bottom end 26. As shown, the serrated plate 20 having a lattice design of diagonally crossed strips and vertically spaced strips defining the serrated plate 20.

The serrated plate 20 further having a width W and a length L (shown in FIG. 1). The overall width W of the serrated plate 20 is slightly greater than the corresponding width of the opening between the forward and rear side encasement sections 114 and 116 of the vehicle window's 100 encasement 110, so that, as will be described, during installation, an approximate midway 27 of the security screen 10 is urged slightly outward along the width W causing the serrated plate 20 to temporarily bend or bow (not shown) so that the ends 22, 24 of the serrated plate 20 can be inserted in the vehicle window 100. Conversely, the overall height H including the brackets 30 as will be discussed, is less than the corresponding vertical height of any vehicle window opening in which its use is intended.

The parameter of the serrated plate 20 is basically rectangular. The corners of the top end 25 can be rounded in conformance with the particular vehicle window 100 so that no gaps exist between vehicle windows 100 top encasement section 112, forward and rear side encasement sections 114, 116, and the serrated plate 20 of the security screen 10. The present invention can thus be easily manufactured to be adapted to most other vehicle window shapes, including windows that are not planar, but have some curve in their surface.

Serrated plates are well known to the metal trade as an expanded steel plate, with trapezoidal clearances, often used as plank grading and in floor plates common to the trade and available from many metal wholesale houses. Preferably, the serrated plate 20 is manufactured from a 9 gauge serrated steel however, both 14 and 12 gauge galvanized serrated steel are common gauges, as is 10 gauge aluminum and 16 gauge stainless steel serrated plates, all of which is acceptable to the present invention. The at least a pair of brackets 30 include a fastening portion 32 and a channel portion 34 opposite the fastening portion 32. The fastening portion 32 of the brackets 30 is affixed to the bottom end 26 of the serrated plate 20 in spaced apart relationship using any attaching means known in the art, including spot welding.

The channel portion 34 of the brackets 30 have a U-shaped configuration, and is intended to receive and guide the glass pane 120 of the vehicle window 100. In application, and as shown in FIG. 3, the security screen 10 is positioned in an upper portion of the vehicle window 100 so that the top end 25 of the serrated plate 20 is guided into the top encasement section 112 of the vehicle window 100, the first and second ends 22, 24 of the serrated plate 20 are positioned within the forward and rear side encasement 114, 116, and the vehicle window glass pane 120 slides upward into the channel 34 of the brackets 30. As such, the security screen 10 is attached to an existing vehicle window encasement in such a manner that the channel 34 of each of the brackets 30 receives the upper edge of the open vehicle window glass pane 120, and the top end 25 and ends 22, 24 of the serrated plate 20 are positioned to insert into the vehicle's encasement 110 as discussed. Moving the window glass slightly upward secures the security screen 10 into the vehicle window 100.

An actual assembly according to a preferred embodiment of the present invention, the serrated plate 20 is manufactured using a 9 gauge galvanized serrated steel. It has been found that using the 9 gauge steel provides adequate security and remains easy to bend or bow during installation. However, it is understood that as the present invention can take on many configurations, it can also have varying dimensions and configurations in order to take on the shape and size of virtually any type of conventional vehicle window.

The preferred method for installing and removing the security screen 10 on a vehicle window 100 is summarized as follows. With the glass pane 120 of the vehicle window 100 lowered as shown in FIG. 2, end 22 of the serrated plate 20 is positioned in the forward side encasement 114 of the vehicle window. The midway 27 of the serrated plate 20 is then urged slightly outward along the width W causing the serrated plate 20 to temporarily bend or bow so that both ends 22, 24 are inserted in the side encasements 114, 116 of the vehicle window 100 as illustrated. The vehicle window glass pane 120 is then raised so that the upper edge of the glass pane 120 is seated in channel 34 in the brackets 30. The vehicle window glass pane 120 is then simply adjusted upward until the top end 25 of the serrated plate 20 is secured within the top encasement section 112 of the vehicle window 100 as shown in FIG. 3. In this position, the entire perimeter of the security screen 10 is secured by the vehicle window encasement 110 and vehicle window glass pane 120 by compression. The security screen 10 is removed simply by lowering the vehicle window glass pane 120 and sliding or snapping the security screen 10 out of the window encasement 110.

Some of the many advantages and novel features of the invention should now be readily apparent. For example, a security screen insert is provided which can be quickly and easily installed to provide some degree of personal privacy and security from intruders. The lattice design of the serrated plate 20 further provides ventilation in the vehicle, while providing minimal disruption of vision out of the vehicle side window. The serrated plate 20 allows for air circulation within the vehicle to alleviate heat buildup in the vehicle. Further, the security screen may be produced in only a few sizes, each size being readily adaptable to a wide range of different window sizes. Selection of materials can be influenced by the amount of security desired. For regions with less problems with security, other materials such as slightly flexible, durable plastic, rather than metal might suffice.

Although the description above contains many specificities, these should not be construed as limiting the scope of the invention but as merely providing illustrations of some of the presently preferred embodiments of this invention.

It will be obvious to those skilled in the art that modifications may be made to the embodiments described above without departing from the scope of the present invention.

Thus the scope of the invention should be determined by the appended claims in the formal application and their legal equivalents, rather than by the examples given.

1. A security screen assembly for a vehicle having a door window opening defined by a window encasement and a window glass slidable in the window encasement, the screen assembly comprising:
a plate having a top end, first and second side ends, a bottom end, a plate-width, and a plate-height, wherein said plate having a generally rectangular configuration and further comprising a lattice design, wherein said top end defined to be received in a top encasement portion of the window encasement, said first side end defined to be received in a first side encasement portion of the window encasement, and said second side end defined to be received in a second side encasement portion of the window encasement,
a pair of brackets attached to said plate in spaced apart relationship, said pair of brackets comprising a fastening portion affixed to said bottom end of the plate, and a channel portion opposite the fastening portion, said channel portion having a U-shaped configuration and sized to receive an upper edge of the window glass, wherein a length of said channel portion in parallel relationship to said bottom end of the plate, wherein said plate-width is slightly greater than the overall width of the door window opening, wherein said plate-height is less than the overall height of the door window opening, and wherein said plate is in compressed relationship between said window encasement and said window glass.

2. The screen assembly as recited in claim 1, wherein the plate is a serrated plate.

3. The screen assembly as recited in claim 2, wherein the plate is manufactured of 9 gauge serrated steel.

4. A screen assembly adaptable to a window opening of a vehicle, the opening having a glass window slidable in a window encasement, said screen assembly comprising:
a serrated plate having a top end defined to be received in a top encasement portion of the window encasement,
a first side end defined to be received in a first side encasement portion of the window encasement,
a second side end defined to be received in a second side encasement portion of the window encasement,
a pair of brackets attached in spaced apart relationship to a bottom end of said serrated plate, said brackets including a channel portion sized and shaped to receive an upper edge of the window glass,
wherein said serrated plate having a width approximately equal to the distance between the first side encasement portion and the second side encasement portion.

5. The screen assembly as recited in claim 4, wherein the serrated plate is in compressed relationship between said window encasement and said window glass.

6. The screen assembly as recited in claim 4, wherein the serrated plate is manufactured of a 9 gauge serrated steel.

7. The screen assembly as recited in claim 4, wherein the serrated plate comprising a lattice design.
